(19) United States
(12) Patent Application Publication
(10) Pub. No.: US 2007/0211713 A1
(43) Pub. Date: Sep. 13, 2007

(54) CONTENT RELAY SERVER, CONTENT REPLAY SYSTEM, CONTENT RELAY METHOD, AND PROGRAM USING THE SAME

(76) Inventors: Toshiharu Koshino, Osaka (JP); Hideaki Takechi, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/593,477

(22) PCT Filed: Feb. 14, 2005
(86) PCT No.: PCT/JP05/02666

§ 371 Date: Sep. 20, 2006

(30) Foreign Application Priority Data
Mar. 30, 2004 (JP) 2004-100996

(51) Int. Cl. H04L 29/08

(52) U.S. Cl. 370/389

(57) ABSTRACT

A content relay server including: an information memory (201) that stores identification information, content information, and the like; a content receiving unit (202) that receives a content; a transfer judgment unit (203) that extracts, from the information memory (201), content information associated with received identification information and judges, based on the content information, whether or not the received content can be received by a content destination apparatus; a content transfer unit 204 that transfers the content to the content destination apparatus identified by the identification information; and a transfer rejection notification unit (205) that provides notice of transfer rejection according to source information.

### TECHNICAL FIELD

The present invention relates to a content relay server that relays contents for transmitting and receiving the contents via a communication network such as the Internet, and a content relay system for transmitting and receiving the contents via the content relay server.

### BACKGROUND ART

A conventional system for transmitting contents via the Internet, as shown in FIG. 1, has been suggested. The contents include text messages, still images and moving images, and they can be transmitted respectively in the form of files of text, JPEG and MPEG-4 formats attached to emails.

For example, Japanese Laid-Open Patent Application Publication No. 2000-261493 describes the invention concerning the above-mentioned system.

In FIG. 1, the content relay server 61 is a server that receives contents attached to emails and transfers them to a content receiving apparatus, a content transmitting 62 is a apparatus that transmits contents, and content storage apparatuses 63 are apparatuses that receive contents transmitted from the content relay server 61 and store them in their internal hard disk drives.

To be more specific, the content transmitting apparatus 62 is a personal computer that is capable of transmitting emails attached with files, and the content storage apparatus 63 is a facsimile machine that is capable of receiving emails attached with JPEG files or a personal computer that is capable of receiving emails and reproducing JPEG and MPEG-4 files.

An email account for each of the content storage apparatuses 63 is registered with the content relay server 61 so as to authorize them to receive emails addressed to them, and the content relay server 61 stores the content information of the content storage apparatus 63 that corresponds to each account. The content information is stored as a content information management table in which the formats and the maximum sizes of contents which can be transferred to respective content storage apparatuses are recorded.

Upon receipt of an email attached with a file addressed to a content storage apparatus 63, the content relay server 61 determines whether or not the attached file is a JPEG-format file, and further determines whether or not it is 100 kB or less in file size. In the case where the attached file satisfies these two conditions, the content relay server 61 transfers the received JPEG file to the content storage apparatus 63.

In the case where the file does not satisfy both conditions, the content relay server 61 converts it into a file of a content which can be received in the content storage apparatus 63, and transfers the converted one to the content storage apparatus 63. For example, if the attached JPEG file is 200 kB in file size, the content relay server 61 reduces the file size by reducing the number of pixels of the file or further compressing it, and then transfers it to the content storage apparatus 63.

However, according to the above-mentioned conventional configuration, as the email clients who access the content relay server increases in number, the load of converting contents is increasingly placed on the content relay server.

The present invention has been conceived in view of the above problem, and a first object of the present invention is to provide a content relay server and a content relay system which need no conversion of contents.

There is another problem. While the content relay server, which has received a content, is converting the content, a user of a content storage apparatus is not informed of the arrival of the content. Therefore, the user has to wait for the arrival of the content impatiently, and further it is too much of a bother for the user to inquire the source of the content about whether or not the content has already been transmitted, or to do something like that.

The present invention has also been conceived in view of the above problem, and a second object of the present invention is to provide a content relay server and a content relay system which allow the users of the content storage apparatus to obtain contents without impatience.

In addition, a third object of the present invention is to provide a content relay server and a content relay system that can respond flexibly to the change in content information from the content source.

There is still another problem. There is a possibility that the content relay server may respond to emails transmitted from malicious third parties. In other words, there is a possibility that a lot of spam mails are transmitted from such malicious third parties, which is objectionable from the viewpoint of security.

So a fourth object of the present invention is to provide a content relay server and a content relay system that can provide notice to a user who is to receive a content that the content has been rejected, while ensuring the security.

### DISCLOSURE OF INVENTION

In order to solve the above problems, the content relay server according to the present invention is a content relay server that relays for relaying a content between a content source apparatus and a content destination apparatus, the content relay server including: an information storing unit operable to store identification information of the content destination apparatus and content information about a content that can be received by the content destination apparatus, the identification information and content information being associated with each other, and operable to store source information about the content source apparatus and destination information about the content destination apparatus; a content receiving unit operable to receive, from the content source apparatus, identification information of the content destination apparatus, a content associated with the identification information, and source information about the content source apparatus; a transfer judging unit operable to extract, from the information storing unit, content information associated with the received identification information of the content destination apparatus, and judge, based on the content information, whether or not the received content can be received by the content destination apparatus; a content transferring unit operable to transfer the received content to the content destination apparatus identified by the identification information when the transfer judging unit judges that the content can be received; and a transfer rejection notifying unit operable to provide notice of a transfer rejection to the content source apparatus based on the source information when the transfer judging unit judges that the content cannot be received.

According to the above configuration, the content relay server only judges whether or not a content can be received, while the load of converting the content is placed on the content source apparatus. Therefore, it becomes possible to eliminate such load of converting contents from the content relay server.

It is also possible that the above content relay server includes an arrival advance notifying unit operable to provide advance notice to the content destination apparatus based on destination information when the transfer judging unit judges that the content cannot be received, the advance notice indicating that the content has arrived at the content relay server but cannot be transferred to the content destination apparatus.

According to the above configuration, even when a content that cannot be received has been transmitted to the content relay server, a user is known that the content has arrived at least at the content relay server. Therefore, it becomes possible for the user to feel at ease while waiting for the converted content.

It is preferable that, in the above content relay server, the information storing unit stores rejection information for rejecting a reception of a content transmitted from a specific source, and that the content relay server further includes a reception rejecting unit operable to judge whether or not the source information transmitted from the content source apparatus is included in the rejection information, and reject a reception of the content and provide notice of the reception rejection to the content source apparatus when the source information is included.

According to the above configuration, even if a malicious third party transmits a lot of contents, the content relay server rejects receipt of them. Therefore, it becomes possible to maintain the security of users.

It is also possible to solve the above problems by a content relay system for transmitting and receiving a content via a content relay server, the content relay system including: a content transmitting apparatus having unique identification information and being operable to transmit a content; a message displaying apparatus which is given an address associated with the content transmitting apparatus; a content storing apparatus operable to store a content; and the above-mentioned content relay server.

Accordingly, it becomes possible to bring about the above-mentioned effects.

The above content relay system may include a destination displaying apparatus operable to receive advance notice of a content arrival and display a message indicating the advance notice.

It is also possible that the above content storing apparatus further includes a content information update requesting unit operable to provide notice of a change in the content information to the content relay server when the content information about the content that can be received has been changed, and the content relay server further includes an information updating unit operable to update the content information stored in the information storing unit upon request from the content information update requesting unit.

Accordingly, it becomes possible to respond flexibly to the change in performance specifications or the like of the content destination.

Note that not only is it possible to embody the present invention as a variety of content relay servers and content relay systems, but also as a variety of content relay methods that include, as steps, the characteristic units included in such servers and systems, and as programs that cause a computer to execute these steps.

It should also be noted that such programs can be distributed on a recording medium such as a CD-ROM (Compact Disc-Read Only Memory) and via a transmission medium such as the Internet.

As further information about technical background to this application, the disclosure of Japanese Patent Application No. 2004-100996 filed on Mar. 30, 2004 including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a schematic diagram showing a configuration of a conventional content relay system;

FIG. 2 is a schematic diagram showing a configuration of a content relay system according to the present invention;

FIG. 3 is a block diagram showing a configuration of a content relay server;

FIG. 4 is a sequence diagram showing a flow of information in the content relay server in the case where a received content can be transferred;

FIG. 5 is a flowchart showing the operations of the content relay server for judging whether or not a content can be transferred;

FIG. 6 is a sequence diagram showing a flow of information in the content relay server in the case where a received content cannot be transferred;

FIG. 7 is a diagram showing a table in which various types of data are associated with each other and stored;

FIG. 8 is a diagram showing a table in which other types of data are associated with each other and stored;

FIG. 9 is a schematic diagram showing a configuration of another content relay system according to the present invention;

FIG. 10 is a sequence diagram showing a flow of information in the another content relay system; and

FIG. 11 is a schematic diagram showing the case where a content is transmitted from a malicious third party.

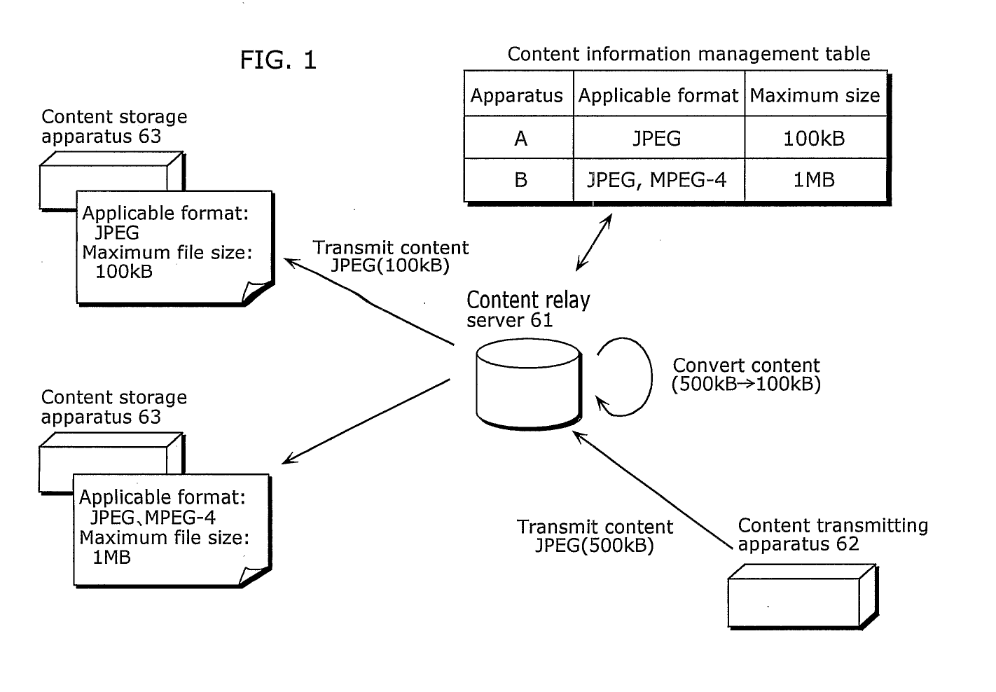

### BEST MODE FOR CARRYING OUT THE INVENTION

The embodiments of the present invention are described below by referring to the drawings.

### First Embodiment

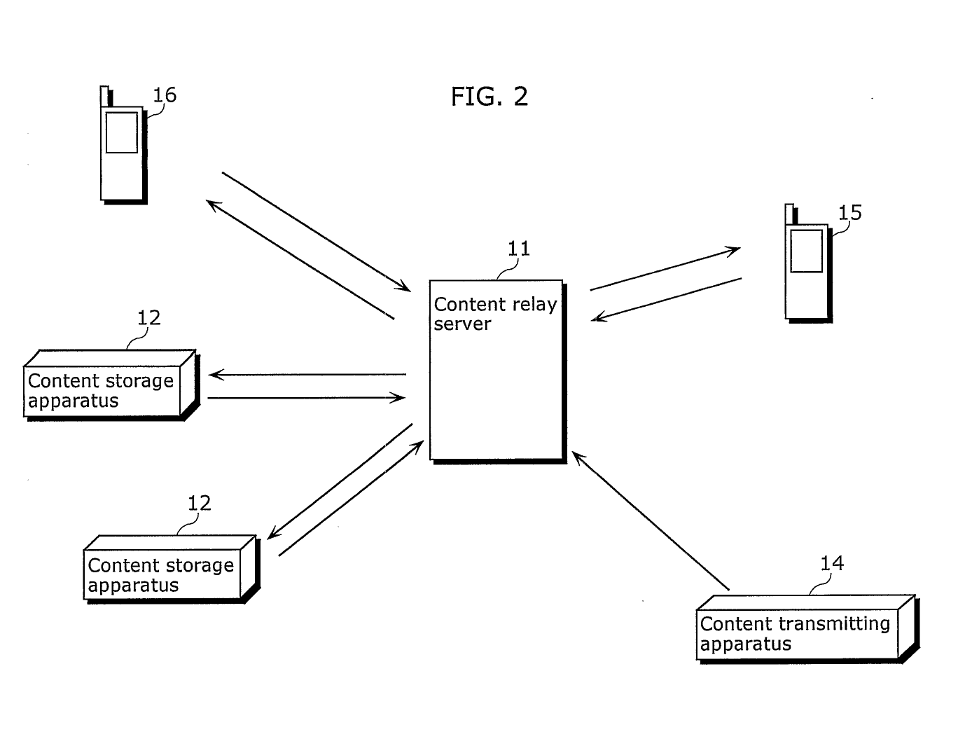

FIG. 2 is a schematic diagram showing a configuration of a content relay system.

The content relay system is a system for transmitting and receiving contents in the form of files by attaching them to emails. The content relay system includes a content relay server 11, content storage apparatuses 12, a content transmitting apparatus 14, a message display apparatus 15, and a destination display apparatus 16.

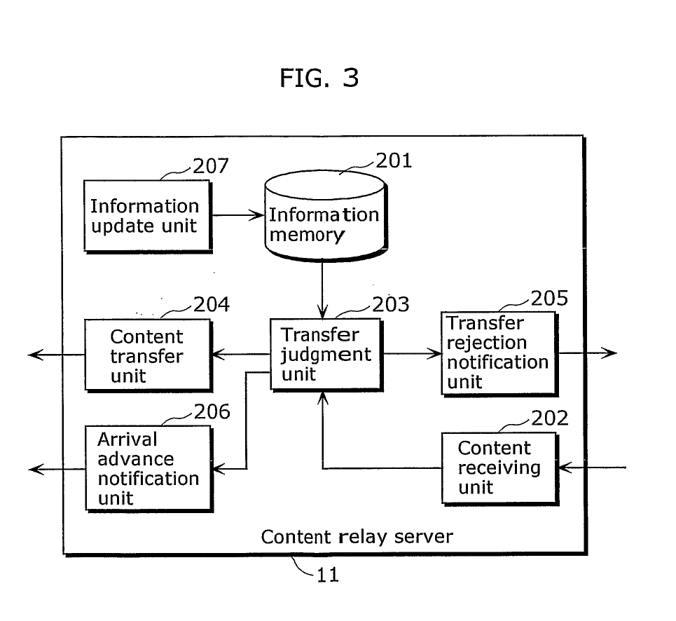

The content relay server 11 relays the contents transmitted in the form of files attached to an email to the addressed content storage apparatuses 12 respectively. As shown in FIG. 3, the content relay server 11 includes an information memory 201 that is an information storing unit, a content receiving unit 202, transfer judgment unit 203, a content transfer unit 204, and a transfer rejection notification unit 205, an arrival advance notification unit 206 and an information update unit 207.

The information memory 201 is a nonvolatile memory such as a hard disk drive that stores identification information and content information which are associated with each other. The identification information is information for identifying each content storage apparatus 12, and the content information is information concerning a content that can be received by each content storage apparatus 12.

The content receiving unit 202 receives the content, the source information and the identification information of the content storage apparatus 12 which are transmitted from the content transmitting apparatus 14.

The transfer judgment unit 203 extracts, from the information memory 201, the content information associated with the received identification information, and judges, based on the content information, whether or not the content storage apparatus 12 can receive the received content.

When it is judged that the content storage apparatus 12 can receive the content, the content transfer unit 204 transfers the content to the content storage apparatus 12 identified by the identification information.

When it is judged that the content storage apparatus 12 cannot receive the content, the transfer rejection notification unit 205 provides notice of transfer rejection to the content source based on the source information.

The content storage apparatus 12 is, for example, a video recorder which is equipped with an Ethernet® interface and placed in a house.

The content transmitting apparatus 14 is a personal computer or a mobile terminal that is capable of transmitting emails.

The message display apparatus 15 and the destination display unit 16 are mobile terminals or the like that are capable of receiving emails.

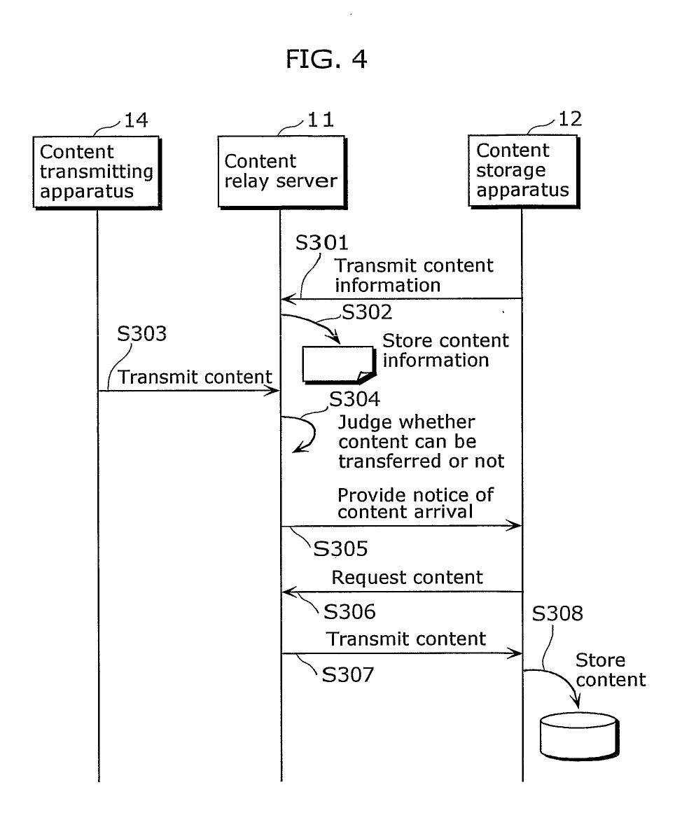

FIG. 4 is a sequence diagram showing communication processes in the case where the content transmitting apparatus 14 transmits a content that can be received and handled by the content storage apparatus 12.

First, the content storage apparatus 12 notifies the content relay server 11 of the content information, namely, the file format and file size of the content that can be received by the content storage apparatus 12, and at the same time, transmits the identification information and the destination information (S301). The file format is notified as a message type to be described later.

The content relay server 11 stores the content information and the like received from the content storage apparatus 12 into the information memory 201 (S302).

Next, the content transmitting apparatus 14 transmits the email attached with a still image of JPEG file format to the content relay server 11 (S303). This email also includes the identification information of the content storage apparatus 12 that is a content destination.

The content relay server 11 judges whether or not the file which is attached to the email in the manner to be described later, namely, the content, can be transferred to the content storage apparatus 12 (S304).

When judging that the content can be transferred to the content storage apparatus 12, the content relay server 11 transmits a content arrival notice to be described later to the content storage apparatus 12 (S305).

In response to the content arrival notice, the content storage apparatus 12 transmits a content request to the content relay server 11 (S306).

In response to the content request, the content relay server 11 transmits the content to the content storage apparatus 12 (S307).

The content storage apparatus 12 stores the content received from the content relay server 11 into the storage unit (S308).

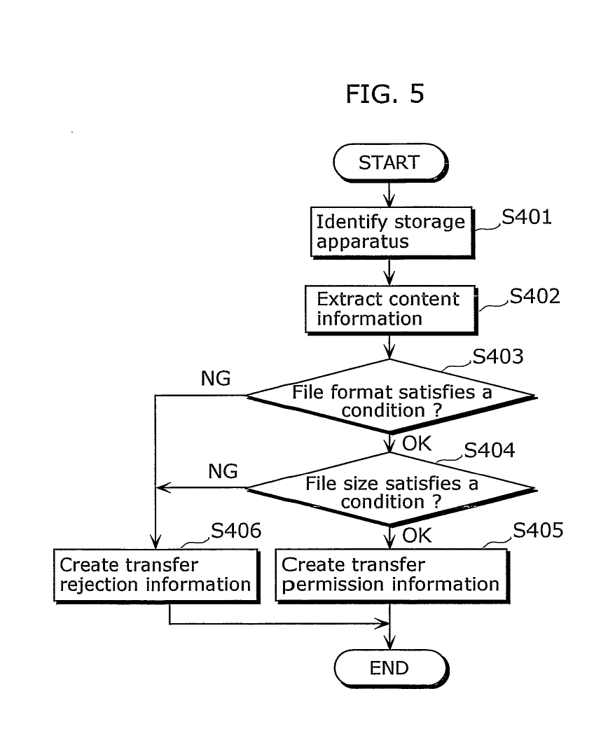

FIG. 5 is a flowchart showing the operations of the content relay server 11 for judging whether or not the transfer of the content is to be rejected.

First, the content relay server 11 identifies, based on the identification information included in the received email, the content storage apparatus 12 as an apparatus to which the content is to be transferred (S401).

Next, the content relay server 11 extracts the content information of the identified content storage apparatus 12 from the information memory 201 (S402).

Next, the content relay server 11 determines, based on the content information, whether or not the attached file is a JPEG file (S403) and whether or not the file size is 100 kB or less (S404), and when both conditions are satisfied, it judges that the content can be transferred and creates transfer permission information (S405). On the other hand, when at least one of the conditions is not satisfied, it creates transfer rejection information (S406).

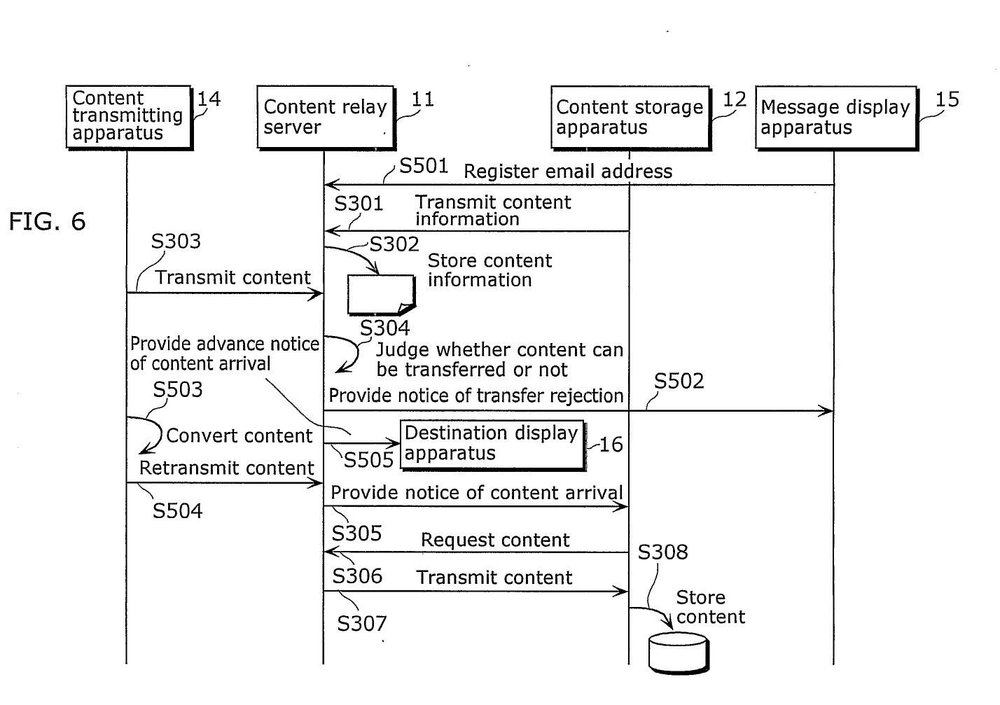

FIG. 6 is a sequence diagram showing communication processes in the case where the content transmitting apparatus 14 has transmitted a content that cannot be received and handled by the content storage apparatus.

First, the message display apparatus 15 registers the source information with the content relay server 11 (S501). A well-known art such as HTTP Protocol can be used as the registration procedure.

The content storage apparatus 12 transmits the content information to the content relay server 11, which stores the received information into the memory (S301 and S302).

The content transmitting apparatus 14 transmits an email attached with a music content of MP3 format to the content relay server 11 (S303).

The content relay server 11 judges based on the above-mentioned procedure whether or not the content can be transferred to the content storage apparatus (S304). It is judged that the content cannot be transferred if it is a content of MP3 format, so the transfer rejection notification unit 205 transmits the transfer rejection information according to the previously stored source information (S502).

Upon receipt of the transfer rejection information, the user converts the content into another format/size of content that can be received by the content storage apparatus (S503). Then, the content transmitting apparatus 14 retransmits the converted content to the content relay server 11 (S504).

On the other hand, the arrival advance notification unit 206 provides advance notice of content arrival to the destination display apparatus 16 (S505).

The user of the content storage apparatus 12, who received this advance notice, can wait for the arrival of the content without impatience.

When it is judged that the content can be transferred to the content storage apparatus 12, the content relay server 11 provides notice of content arrival to the content storage apparatus 12 (305). Upon receipt of the content arrival notice, the content storage apparatus 12 transmits a content request to the content relay server 11 (S306). Upon receipt of the content request, the content relay server 11 transmits the content to the content storage apparatus 12 (S307). The content storage apparatus 12 stores the content received from the content relay server 11 into the storage unit (S308).

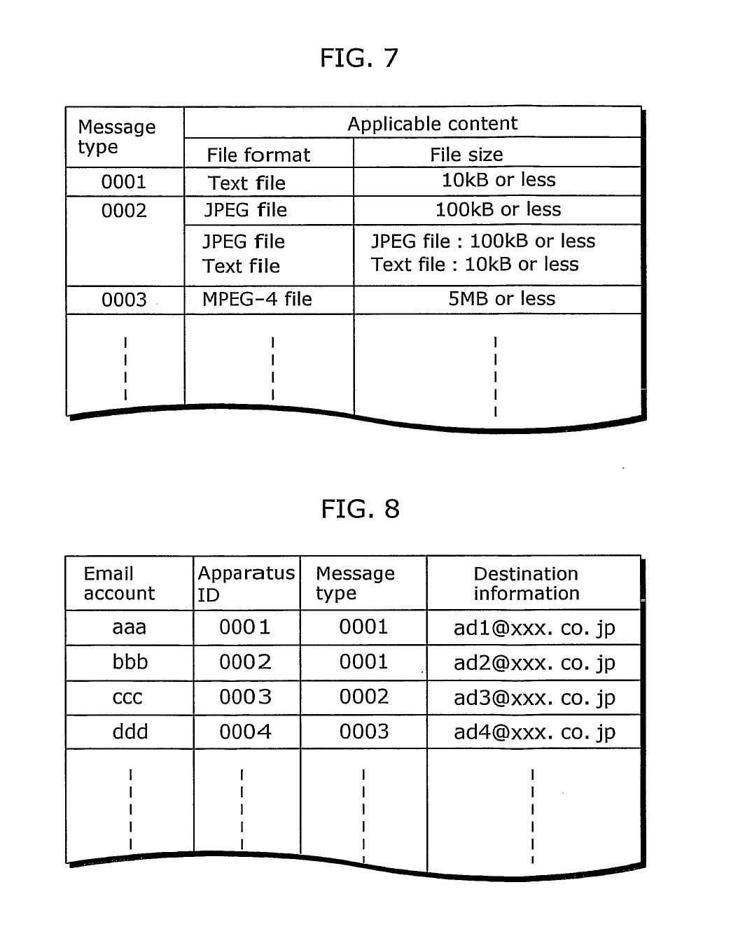

FIG. 7 is a diagram showing, in tabular form, the content information and the like stored in the information memory 201.

The types of contents that can be received and handled by each content storage apparatus 12 are previously defined as message types as shown in FIG. 7.

The table shows the conditions for each type of content, under which each content storage apparatus can receive the content. In more detail, a message type 0001 shows the conditions of a text file only and the file size of 10 kB or less.

A message type 0002 shows the conditions of a JPEG file or a combination of a JPEG file and a text file and 100 kB or less in JPEG file size and 10 kB or less in text file size respectively.

A message type 0003 shows the conditions of an MPEG-4 file only and the file size of 5 MB or less.

When the file attached to the received email satisfies the conditions as shown in each message type, the content relay server 11 provides notice of content arrival to the content storage apparatus 12 (S305). When the file does not satisfy the conditions, the content relay server 11 provides notice of transfer rejection according to the source information transmitted from the message display apparatus 15 (S502).

The content storage apparatus 12 notifies the content relay server 11 of, as content information, a message type that defines contents that the content storage apparatus 12 itself can receive. The content storage apparatus 12 also notifies the content relay server of the identification information including the apparatus ID which is preset in itself. The content relay server 11 stores the correspondence between the identification information and the message types into the information memory 201. The identification information includes email accounts for transmitting contents.

FIG. 8 is a diagram showing, in tabular form, other information stored in the information memory 201.

Upon receipt of an email, the content relay server 11 identifies a content storage apparatus 12 that corresponds to the identification information stored in the information memory 201, and compares the message type of the identified content storage apparatus 12 with the file attached to the email.

In the case where the message type is 0001, when the file attached to the email is a text file and the size of the text file is 10 kB or less, the content relay server 11 provides notice of content arrival to the content storage apparatus 12 (S305). When the attached file does not satisfy these conditions, the content relay server 11 provides notice of transfer rejection to the message display apparatus according to the destination information (S502).

In the case where the message type is 0002, when a JPEG file only or two files of a JPEG file and a text file are attached to the e-mail and the file sizes of these files satisfy the conditions respectively, the content relay server 11 provides notice of content arrival to the content storage apparatus 12 (S305). When the file(s) attached to the email does not satisfy the conditions, the content relay server 11 provides notice of transfer rejection to the message display apparatus according to the destination information (S502).

In the case where the message type is 0003, when the file attached to the email is an MPEG-4 file and the size of the file is 5 MB or less, the content relay server 11 provides notice of content arrival to the content storage apparatus 12 (S305). When the attached file does not satisfy the conditions, the content relay server 11 provides notice of transfer rejection to the message display apparatus according to the content destination information (S502).

As described above, according to the present embodiment, in the case where a content that cannot be received and handled by a content storage apparatus is transmitted, the content relay server notifies the source of the content that the content cannot be transferred, and the content source apparatus converts the content into another format/size of content that can be handled by the content storage apparatus. Therefore, no load for converting the content is put on the content relay server.

In addition, since the content relay server provides notice to a user that a content could not be transferred to a content destination apparatus, the user of the content destination apparatus can wait for the arrival of the content without impatience.

### Second Embodiment

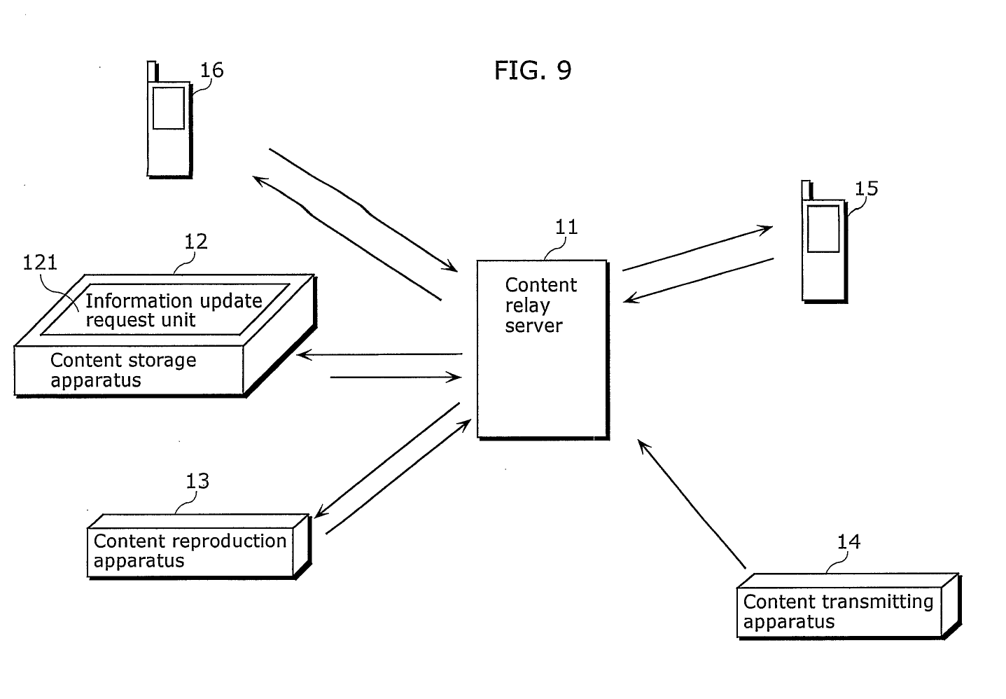

FIG. 9 is a schematic diagram showing a configuration of a content relay system according to another embodiment of the present invention. In this content relay system, the content storage apparatus 12, the content reproduction apparatus 13 and the content transmitting apparatus 14 are connected to the content relay server 11 via the Internet.

The content storage apparatus 12 is a video recorder which is placed in a house and equipped with an Ethernet® interface, and includes an information update request unit 121 that is capable of notifying of change in content information when a content that can be received is changed.

The content reproduction apparatus 13 is a television apparatus which is equipped with an Ethernet® interface and is capable of displaying contents of images, characters and the like. In other words, it is an apparatus that is capable of displaying contents stored in the content storage apparatus 12 via the Ethernet®.

The content transmitting apparatus 14 is a personal computer, a mobile terminal or the like that is capable of transmitting emails.

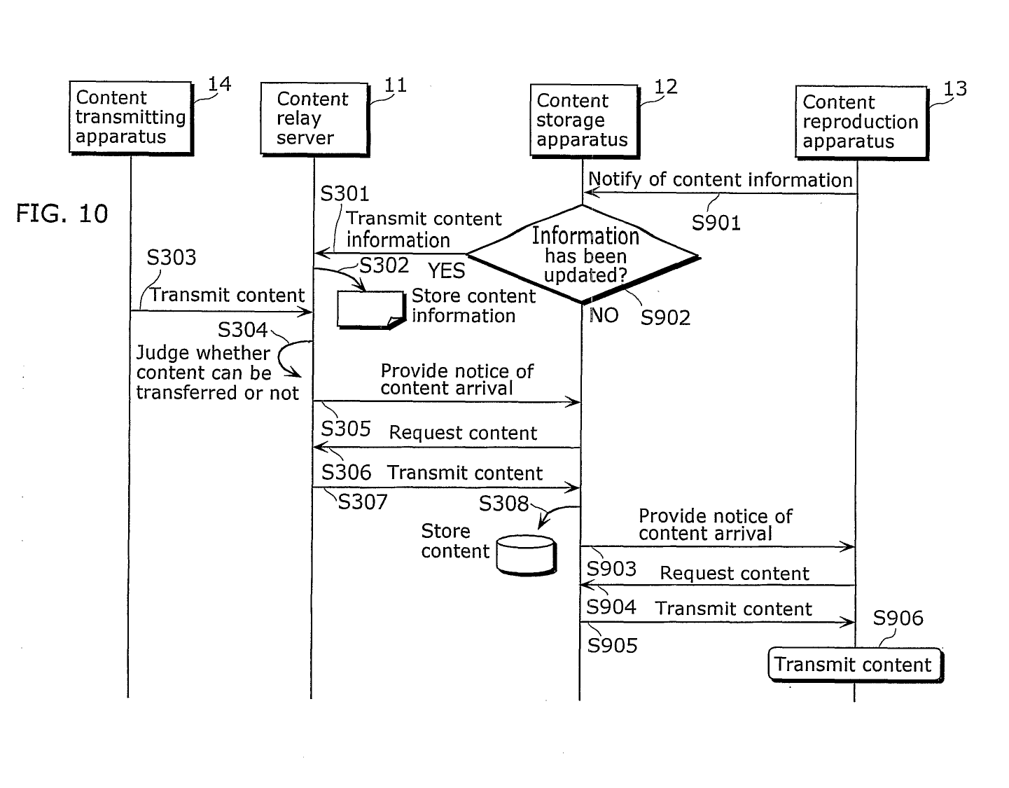

FIG. 10 is a sequence diagram showing a communication processes for relaying contents.

First, the content reproduction apparatus 13 notifies the content storage apparatus 12 of information of a content that can be reproduced. To be more specific, the file format and the maximum file size of the content are notified (S901). The information update request unit 121 in the content storage apparatus 12 judges whether or not the content that can be stored or reproduced by the content storage apparatus 12 itself or the content reproduction apparatus 13 has been changed in its format/size (S902). When the content has not been changed (NO in S902), the content information and the like are not transmitted to the content relay server 11. When the content has been changed (YES in S902), the content storage apparatus 12 transmits, to the content relay server 11, the content information indicating that the content reproduction apparatus 13 can reproduce a JPEG file of 100 kB or less in file size (S301). The file format and the like are notified as a message type.

The information update unit 207 in the content relay server 11 obtains the content information and updates the information stored in the information memory 201. The content relay server 11 stores the content information received from the content storage apparatus 12 into the information memory 201 (S302).

The content transmitting apparatus 14 transmits an email attached with a still image of JPEG file format to the content relay server 11 (S303).

In the content relay server 11, the identification information and the destination information which are associated with the content storage apparatus 12 are previously stored.

The content relay server 11 judges, according to the following procedure, whether or not the file attached to the email, namely, a content, can be transferred to the content storage apparatus 12. First, the content relay server 11 identifies, based on the identification information included in the received email, the content storage apparatus 12 as an apparatus to which the content should be transferred (S401). Then, it extracts the content information of the content storage apparatus 12 from the information memory 201 (S402). The content relay server 11 determines, based on the content information, whether or not the attached file is a JPEG file (S403) and whether or not the file size is 100 kB or less (S404), and when the content satisfies both conditions, it judges that the content can be transferred.

When judging that the content can be transferred to the content storage apparatus 12, the content relay server 11 provides notice of content arrival to the content storage apparatus 12 (S305).

In response to the notice of content arrival, the content storage apparatus 12 transmits a content request to the content relay server 11 (S306).

In response to the content request, the content relay server 11 transmits a JPEG file to the content storage apparatus 12 (S307).

The content storage apparatus 12 stores the content received from the content relay server 11 into the storage unit (S308).

The content storage apparatus 12 provides notice of content arrival to the content reproduction apparatus 13 (S903).

In response to the notice of content arrival, the content reproduction apparatus 13 requests the content storage apparatus 12 for the content (S904).

In response to the content request, the content storage apparatus 12 transmits the content to the content reproduction apparatus 13 (S905).

The content reproduction apparatus 13 reproduces the content and displays the still image (S906).

Note that in the case where the content relay server 11 judges that the received content cannot be transferred to the content storage apparatus 12, it transmits a transfer rejection notice to a predetermined email address. In response to the transfer rejection notice, the user who transmitted the content can convert the content into another format/size of content that can be reproduced by the content reproduction apparatus, and transmit the converted content again to the content relay server 11 using the content transmitting apparatus 14.

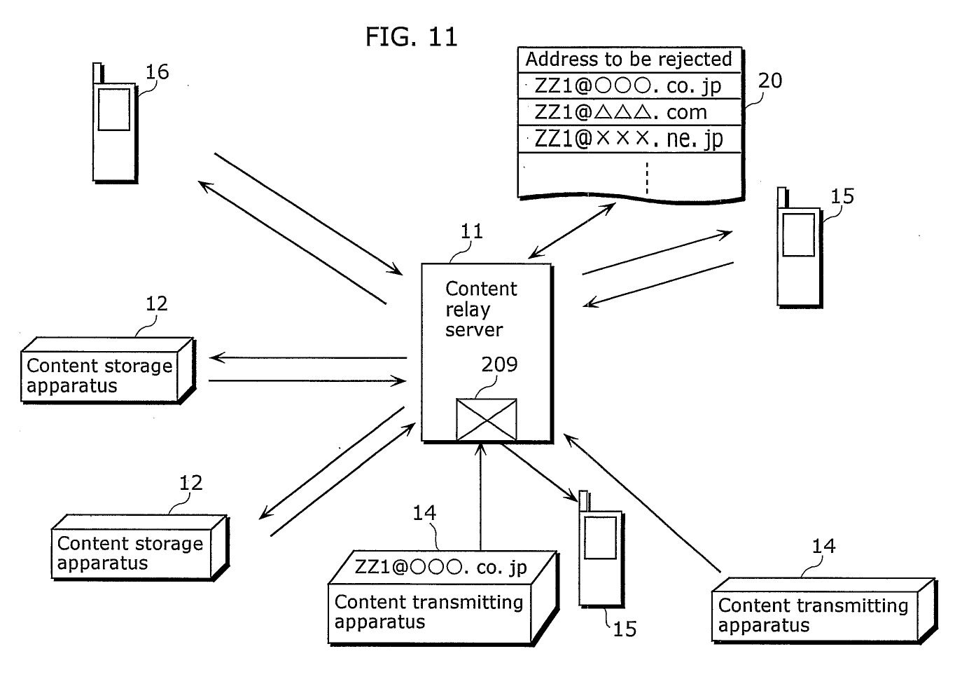

In addition, as shown in FIG. 11, in the case where rejection information 20 includes the source information of a content transmitting apparatus 14, namely, the source which transmitted a content to the content relay server 11, the reception rejection unit 209 of the content relay server 11 rejects reception of the content and provides notice of reception rejection to the content source apparatus according to the source information.

As described above, according to the present embodiment, information of a content that can be reproduced is previously stored in a content relay server, and only the content information is updated without changing identification information, even if the content information is changed. Therefore, it becomes possible to change or replace a content storage apparatus or a content reproduction apparatus without restraint.

In addition, since an email from a malicious third party is rejected by the reception rejection unit, it is possible to improve the security.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be applied to a content relay system for relaying contents from a content transmitting apparatus such as a personal computer and a cell phone to a video recorder and a television apparatus, and a content relay server or the like to be used for the system. Particularly, it can be applied to a content relay system for transmitting and receiving contents of file format attached to emails or the like, and a content relay server or the like to be used for the system.

1-9. (canceled)

10. A content relay server for relaying a content between a content source apparatus and a content destination apparatus, said content relay server comprising:
an information storing unit operable to store identification information of the content destination apparatus and content information about a content that can be received by the content destination apparatus, the identification information and content information being associated with each other, and operable to store source information about the content source apparatus and destination information about the content destination apparatus;
a content receiving unit operable to receive, from the content source apparatus, identification information of the content destination apparatus, a content associated with the identification information, and source information about the content source apparatus;
a transfer judging unit operable to extract, from said information storing unit, content information associated with the received identification information of the content destination apparatus, and judge, based on the content information, whether or not the received content can be received by the content destination apparatus;
a content transferring unit operable to transfer the received content to the content destination apparatus identified by the identification information when said transfer judging unit judges that the content can be received; and
a transfer rejection notifying unit operable to provide notice of a transfer rejection to at least one of a message displaying apparatus and a destination displaying apparatus when said transfer judging unit judges that the content cannot be received.

11. The content relay server according to claim 10, further comprising
an arrival advance notifying unit operable to provide advance notice to the content destination apparatus based on destination information when said transfer judging unit judges that the content cannot be received, the advance notice indicating that the content has arrived at said content relay server but cannot be transferred to the content destination apparatus.

12. The content relay server according to claim 10, wherein:
said information storing unit is operable to store rejection information for rejecting a reception of a content transmitted from a specific source; and
said content relay server further comprises
a reception rejecting unit operable to judge whether or not the source information transmitted from the content source apparatus is included in the rejection information, and reject a reception of the content and provide notice of the reception rejection to the content source apparatus when the source information is included.

13. The content relay server according to claim 10, wherein:
said information storing unit is operable to store rejection information for rejecting a reception of a content transmitted from a specific source; and
said content relay server further comprises
a reception rejecting unit operable to judge whether or not the source information transmitted from the content source apparatus is included in the rejection information, and reject a reception of the content.

14. A content relay system for transmitting and receiving a content via a content relay server, said content relay system comprising:
a content transmitting apparatus having unique identification information and being operable to transmit a content;
a message displaying apparatus which is given an address associated with said content transmitting apparatus;
a content storing apparatus operable to store a content; and
a content relay server operable to relay a content, said content relay server comprising:
an information storing unit operable to store identification information of a content destination apparatus and content information about a content that can be received by the content destination apparatus, the identification information and content information being associated with each other, and operable to store source information about a content source apparatus and destination information about the content destination apparatus;
a content receiving unit operable to receive, from the content source apparatus, identification information of the content destination apparatus, a content associated with the identification information, and source information about the content source apparatus;
a transfer judging unit operable to extract, from said information storing unit, content information associated with the received identification information of the content destination apparatus, and judge, based on the content information, whether or not the received content can be received by the content destination apparatus;
a content transferring unit operable to transfer the received content to the content destination apparatus identified by the identification information when said transfer judging unit judges that the content can be received; and
a transfer rejection notifying unit operable to provide notice of a transfer rejection to the content source apparatus based on the source information when said transfer judging unit judges that the content cannot be received.

15. The content relay system according to claim 14, further comprising
a destination displaying apparatus operable to receive advance notice of a content arrival and display a message indicating the advance notice.

16. The content relay system according to claim 14, wherein:
said the content storing apparatus further comprises
a content information update requesting unit operable to provide notice of a change in the content information to said content relay server when the content information about the content that can be received has been changed; and
said content relay server further comprises
an information updating unit operable to update the content information stored in said information storing unit upon request from said content information update requesting unit.

17. A content relay method by which a content relay server relays a content, the content relay server including an information storing unit operable to store identification information of a content destination apparatus and content information about a content that can be received by the content destination apparatus, the identification information and content information being associated with each other, and operable to store source information about the content source apparatus and destination information about the content destination apparatus, said content relay method comprising:
receiving, from the content source apparatus, identification information of the content destination apparatus, a content associated with the identification information, and source information about the content source apparatus;
extracting, from the information storing unit, content information associated with the received identification information of the content destination apparatus, and judging, based on the content information, whether or not the received content can be received by the content destination apparatus;
transferring the received content to the content destination apparatus identified by the identification information when it is judged that the content can be received; and
providing notice of a transfer rejection to at least one of a message displaying apparatus and a destination displaying apparatus when it is judged that the content cannot be received.

18. A program for relaying a content between a content source apparatus and a content destination apparatus, said program comprising executable code operable to cause a computer to perform:
receiving, from the content source apparatus, identification information of the content destination apparatus, a content associated with the identification information, and source information about the content source apparatus;
extracting, from the information storing unit, content information associated with the received identification information of the content destination apparatus, and judging, based on the content information, whether or not the received content can be received by the content destination apparatus;
transferring the received content to the content destination apparatus identified by the identification information when it is judged that the content can be received; and
providing notice of a transfer rejection to the content source apparatus based on the source information when it is judged that the content cannot be received.
